(19) United States
(12) Patent Application Publication
(10) Pub. No.: US 2022/0222276 A1
(43) Pub. Date: Jul. 14, 2022

(54) Content Acquisition System and Method

(71) Applicant: FitElephants LLC, Boston, MA (US)

(72) Inventor: Hercules G. Haseotes, Sudbury, MA (US)

(21) Appl. No.: 17/573,432

(22) Filed: Jan. 11, 2022

Related U.S. Application Data
(60) Provisional application No. 63/136,145, filed on Jan. 11, 2021.

(51) Int. Cl. G06F 16/27

(52) U.S. Cl. CPC G06F 16/273

(57) ABSTRACT

A computer-implemented method, computer program product and computing system for saving a recording of an event on an accessible storage platform; enabling the asynchronous review of the recording of the event by one or more asynchronous attendees; and memorializing the asynchronous review of the recording of the event by the one or more asynchronous attendees.

### RELATED APPLICATION(S)

This application claims the benefit of U.S. Provisional Application No. 63/136,145 filed on 11 Jan. 2021, the entire contents of which is incorporated herein by reference.

### TECHNICAL FIELD

This disclosure relates to content acquisition systems and methods and, more particularly, to content acquisition systems and methods that allow for asynchronous viewing of content.

### BACKGROUND

When events take place (be it business meetings, celebrity interviews, musical concerts, exercise classes, etc.), these events may be attended by in person attendees as well as others who may watch the event remotely (be it by watching a broadcast or a stream of the event). Additionally, the event may be recorded and made available for asynchronous (e.g., non-live) viewing so that additional people may review the recording of the event.

Unfortunately, to enable such asynchronous viewing of an event may require the execution of many discrete and separate tasks. For example, the event may need to be recorded locally and then this recording may need to be uploaded to a widely-available storage location (e.g., cloud-based storage). This recording may then need to be made available for review by third parties on an asynchronous basis, thus requiring many tasks to be completed in order to effectuate the desired goal.

### Summary of Disclosure

### Concept 2

In one implementation, a computer-implemented method executed on a computing device includes: saving a recording of an event on an accessible storage platform; enabling the asynchronous review of the recording of the event by one or more asynchronous attendees; and memorializing the asynchronous review of the recording of the event by the one or more asynchronous attendees.

One or more of the following features may be included. The event may be defined. Defining an event may include one or more of: scheduling an event using an event platform; and scheduling a time, a date and a periodicity for the event. Saving a recording of the event on an accessible storage platform may include: automatically saving a recording of the event on a cloud-based storage platform. Saving a recording of the event on an accessible storage platform may include: automatically saving the recording of the event on a local storage device; and automatically uploading the recording of the event from the local storage device to a cloud-based storage platform. Enabling the asynchronous review of the recording of the event by one or more asynchronous attendees may include: enabling the one or more asynchronous attendees to stream the recording of the event. Enabling the asynchronous review of the recording of the event by one or more asynchronous attendees may include: enabling the one or more asynchronous attendees to download the recording of the event. Memorializing the asynchronous review of the recording of the event by the one or more asynchronous attendees may include: certifying the asynchronous review of the recording of the event by the one or more asynchronous attendees, thus generating one or more certifications. Memorializing the asynchronous review of the recording of the event by the one or more asynchronous attendees may include: providing the one or more certifications to a third-party certification entity. The event may be streamed for synchronous viewing/participation by one or more remote attendees. The recording of the event may include one or more of: an audio component; a video component; a graphical component; and a text component.

In another implementation, a computer program product resides on a computer readable medium and has a plurality of instructions stored on it. When executed by a processor, the instructions cause the processor to perform operations including saving a recording of an event on an accessible storage platform; enabling the asynchronous review of the recording of the event by one or more asynchronous attendees; and memorializing the asynchronous review of the recording of the event by the one or more asynchronous attendees.

One or more of the following features may be included. The event may be defined. Defining an event may include one or more of: scheduling an event using an event platform; and scheduling a time, a date and a periodicity for the event. Saving a recording of the event on an accessible storage platform may include: automatically saving a recording of the event on a cloud-based storage platform. Saving a recording of the event on an accessible storage platform may include: automatically saving the recording of the event on a local storage device; and automatically uploading the recording of the event from the local storage device to a cloud-based storage platform. Enabling the asynchronous review of the recording of the event by one or more asynchronous attendees may include: enabling the one or more asynchronous attendees to stream the recording of the event. Enabling the asynchronous review of the recording of the event by one or more asynchronous attendees may include: enabling the one or more asynchronous attendees to download the recording of the event. Memorializing the asynchronous review of the recording of the event by the one or more asynchronous attendees may include: certifying the asynchronous review of the recording of the event by the one or more asynchronous attendees, thus generating one or more certifications. Memorializing the asynchronous review of the recording of the event by the one or more asynchronous attendees may include: providing the one or more certifications to a third-party certification entity. The event may be streamed for synchronous viewing/participation by one or more remote attendees. The recording of the event may include one or more of: an audio component; a video component; a graphical component; and a text component.

In another implementation, a computing system includes a processor and a memory system configured to perform operations including saving a recording of an event on an accessible storage platform; enabling the asynchronous review of the recording of the event by one or more asynchronous attendees; and memorializing the asynchronous review of the recording of the event by the one or more asynchronous attendees.

One or more of the following features may be included. The event may be defined. Defining an event may include one or more of: scheduling an event using an event platform; and scheduling a time, a date and a periodicity for the event. Saving a recording of the event on an accessible storage platform may include: automatically saving a recording of the event on a cloud-based storage platform. Saving a recording of the event on an accessible storage platform may include: automatically saving the recording of the event on a local storage device; and automatically uploading the recording of the event from the local storage device to a cloud-based storage platform. Enabling the asynchronous review of the recording of the event by one or more asynchronous attendees may include: enabling the one or more asynchronous attendees to stream the recording of the event. Enabling the asynchronous review of the recording of the event by one or more asynchronous attendees may include: enabling the one or more asynchronous attendees to download the recording of the event. Memorializing the asynchronous review of the recording of the event by the one or more asynchronous attendees may include: certifying the asynchronous review of the recording of the event by the one or more asynchronous attendees, thus generating one or more certifications. Memorializing the asynchronous review of the recording of the event by the one or more asynchronous attendees may include: providing the one or more certifications to a third-party certification entity. The event may be streamed for synchronous viewing/participation by one or more remote attendees. The recording of the event may include one or more of: an audio component; a video component; a graphical component; and a text component.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of a distributed computing network including a computing device that executes a content acquisition process according to an embodiment of the present disclosure;

FIG. 2 is a diagrammatic view of a video platform for executing the content acquisition process of FIG. 1 according to an embodiment of the present disclosure; and

FIG. 3 is a flowchart of the content acquisition process of FIG. 1 according to an embodiment of the present disclosure.

Like reference symbols in the various drawings indicate like elements.

### DETAILED DESCRIPTION OF THE PREFERRED EMBODIMENTS

### System Overview

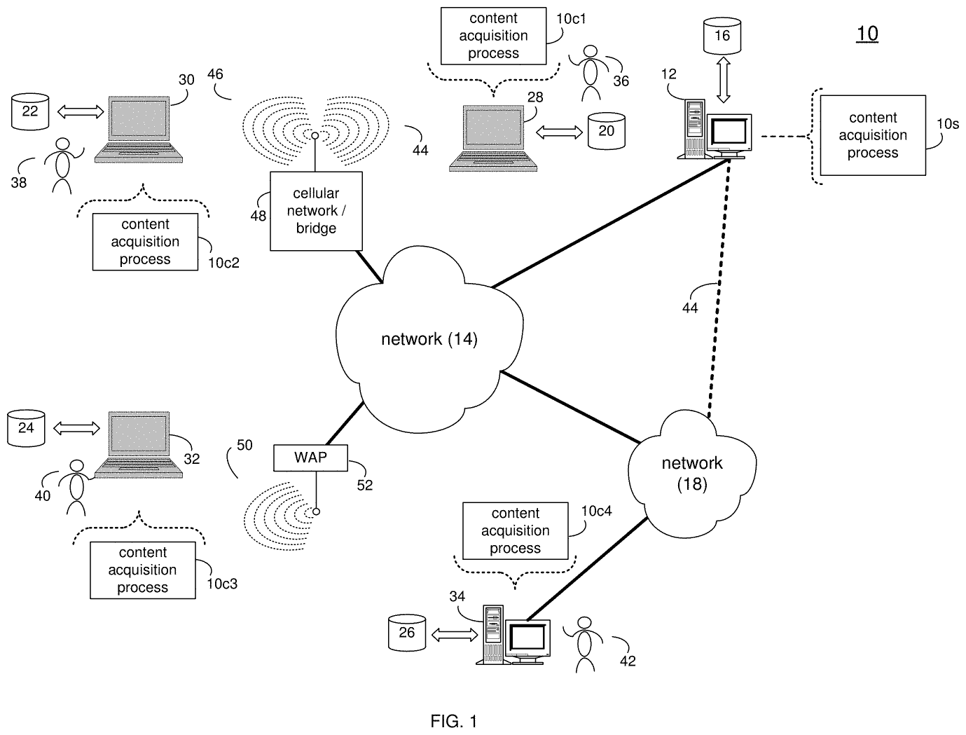

Referring to FIG. 1, there is shown content acquisition process 10. Content acquisition process 10 may be implemented as a server-side process, a client-side process, or a hybrid server-side/client-side process. For example, content acquisition process 10 may be implemented as a purely server-side process via content acquisition process 10s. Alternatively, content acquisition process 10 may be implemented as a purely client-side process via one or more of content acquisition process 10c1, content acquisition process 10c2, content acquisition process 10c3, and content acquisition process 10c4. Alternatively still, content acquisition process 10 may be implemented as a hybrid server-side/client-side process via content acquisition process 10s in combination with one or more of content acquisition process 10c1, content acquisition process 10c2, content acquisition process 10c3, and content acquisition process 10c4. Accordingly, content acquisition process 10 as used in this disclosure may include any combination of content acquisition process 10s, content acquisition process 10c1, content acquisition process 10c2, content acquisition process 10c3, and content acquisition process 10c4.

Content acquisition process 10s may be a server application and may reside on and may be executed by computing device 12, which may be connected to network 14 (e.g., the Internet or a local area network). Examples of computing device 12 may include, but are not limited to: a personal computer, a server computer, a series of server computers, a mini computer, a mainframe computer, a smartphone, or a cloud-based computing platform.

The instruction sets and subroutines of content acquisition process 10s, which may be stored on storage device 16 coupled to computing device 12, may be executed by one or more processors (not shown) and one or more memory architectures (not shown) included within computing device 12. Examples of storage device 16 may include but are not limited to: a hard disk drive; a RAID device; a random access memory (RAM); a read-only memory (ROM); and all forms of flash memory storage devices.

Network 14 may be connected to one or more secondary networks (e.g., network 18), examples of which may include but are not limited to: a local area network; a wide area network; or an intranet, for example.

Examples of content acquisition processes 10c1, 10c2, 10c3, 10c4 may include but are not limited to a web browser, a game console user interface, a mobile device user interface, or a specialized application (e.g., an application running on e.g., the Android™ platform, the iOS™ platform, the Windows™ platform, the Linux™ platform or the UNIX™ platform). The instruction sets and subroutines of content acquisition processes 10c 1, 10c2, 10c3, 10c4, which may be stored on storage devices 20, 22, 24, 26 (respectively) coupled to client electronic devices 28, 30, 32, 34 (respectively), may be executed by one or more processors (not shown) and one or more memory architectures (not shown) incorporated into client electronic devices 28, 30, 32, 34 (respectively). Examples of storage devices 20, 22, 24, 26 may include but are not limited to: hard disk drives; RAID devices; random access memories (RAM); read-only memories (ROM), and all forms of flash memory storage devices.

Examples of client electronic devices 28, 30, 32, 34 may include, but are not limited to, a smartphone (not shown), a personal digital assistant (not shown), a tablet computer (not shown), laptop computers 28, 30, 32, personal computer 34, a notebook computer (not shown), a server computer (not shown), a gaming console (not shown), and a dedicated network device (not shown). Client electronic devices 28, 30, 32, 34 may each execute an operating system, examples of which may include but are not limited to Microsoft Windows™, Android™, iOS™, Linux™, or a custom operating system.

Users 36, 38, 40, 42 may access content acquisition process 10 directly through network 14 or through secondary network 18. Further, content acquisition process 10 may be connected to network 14 through secondary network 18, as illustrated with link line 44.

The various client electronic devices (e.g., client electronic devices 28, 30, 32, 34) may be directly or indirectly coupled to network 14 (or network 18). For example, laptop computer 28 and laptop computer 30 are shown wirelessly coupled to network 14 via wireless communication channels 44, 46 (respectively) established between laptop computers 28, 30 (respectively) and cellular network/bridge 48, which is shown directly coupled to network 14. Further, laptop computer 32 is shown wirelessly coupled to network 14 via wireless communication channel 50 established between laptop computer 32 and wireless access point (i.e., WAP) 52, which is shown directly coupled to network 14. Additionally, personal computer 34 is shown directly coupled to network 18 via a hardwired network connection.

WAP 52 may be, for example, an IEEE 802.11a, 802.11b, 802.11g, 802.11n, Wi-Fi, and/or Bluetooth device that is capable of establishing wireless communication channel 50 between laptop computer 32 and WAP 52. As is known in the art, IEEE 802.11x specifications may use Ethernet protocol and carrier sense multiple access with collision avoidance (i.e., CSMA/CA) for path sharing. As is known in the art, Bluetooth is a telecommunications industry specification that allows e.g., mobile phones, computers, and personal digital assistants to be interconnected using a short-range wireless connection.

Content Acquisition Systems (Overview)

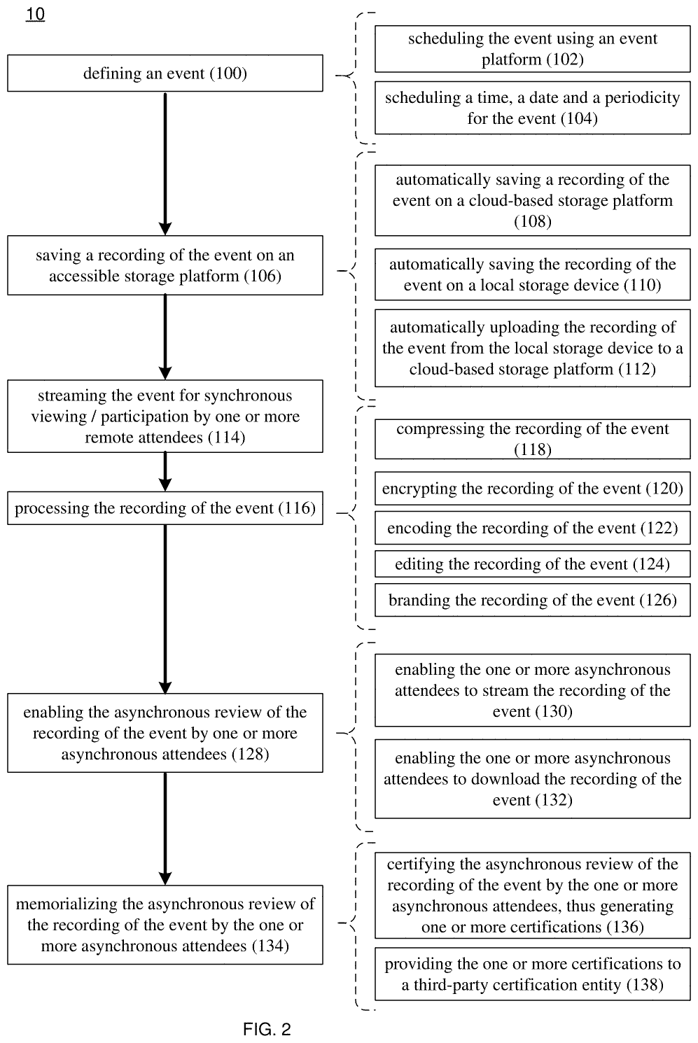

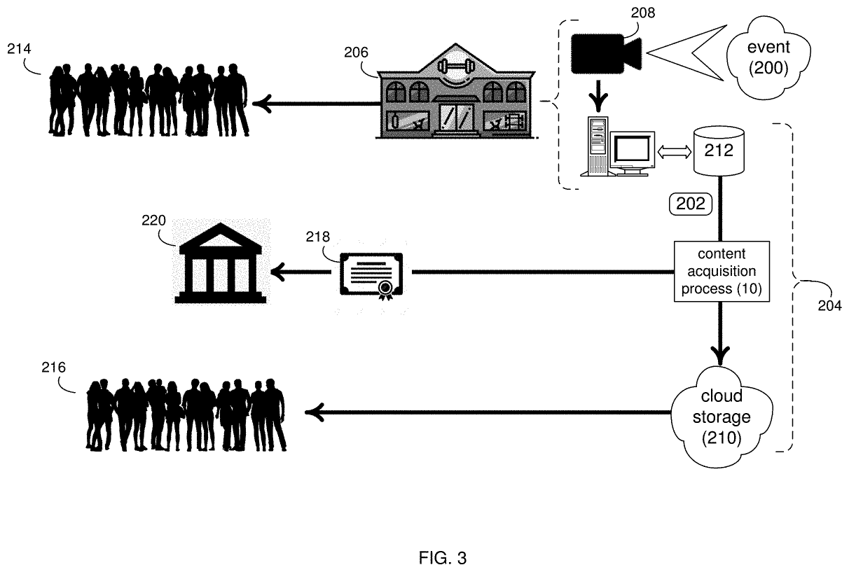

Referring also to FIGS. 2-3, assume for that content acquisition process 10 may define 100 an event (e.g., event 200). When defining 100 an event (e.g., event 200), such definition of such an event (e.g., event 200) may be effectuated natively through content acquisition process 10. Examples of such events (e.g., event 200) may include but are not limited to business meetings, celebrity interviews, musical concerts, exercise classes, sporting events, awards shows, political rallies, etc.

When defining 100 an event (e.g., event 200), content acquisition process 10 may schedule 102 the event (e.g., event 200) using an event platform (e.g., Zoom™, Amazon Chime™ or Microsoft Teams™). Additionally/alternatively, the event (e.g., event 200) may be defined 100 in a more traditional fashion using more general calendaring software such as Microsoft Outlook™ and Google Calendar™.

Additionally and when defining 100 an event (e.g., event 200), content acquisition process 10 may schedule 104 a time, a date and a periodicity for the event (e.g., event 200). For this example, assume that the event (e.g., event 200) is a personal training event being held at a local gym in Los Angeles, Calif. and being headlined by Jillian Michaels (i.e., an American personal trainer, businesswoman, author and television personality). Assume that when defining 100 this event (e.g., event 200), content acquisition process 10 may schedule 104 a time (noon PST), a date (1 Jun. 2022) and a periodicity (once) for the event (e.g., event 200), wherein the coordinator of this event (e.g., event 200) schedules 102 this event (e.g., event 200) using the event platform Amazon Chime™.

Assume for this example that the event (e.g., event 200) occurs as scheduled, wherein content acquisition process 10 may save 106 a recording (e.g., recording 202) of the event (e.g., event 200) on an accessible storage platform (e.g., accessible storage platform 204). Accordingly, the facility (e.g., gym 206) hosting the event (e.g., event 200) may be equipped with the hardware/systems (e.g., hardware/systems 208) necessary for generating the recording (e.g., recording 202) of the event (e.g., event 200). Examples of hardware/systems 208 may include but are not limited to one or more cameras, one or more microphones, etc.

When saving 106 a recording (e.g., recording 202) of the event (e.g., event 200) on an accessible storage platform (e.g., accessible storage platform 204), content acquisition process 10 may automatically save 108 the recording (e.g., recording 202) of the event (e.g., event 200) on a cloud-based storage platform (e.g., cloud-based storage platform 210). Examples of such a cloud-based storage platform (e.g., cloud-based storage platform 210) may include but are not limited to Amazon Web Services™, Microsoft Azure™, and the Google Cloud Platform™. Accordingly and is such a configuration, content acquisition process 10 may capture information relating to the event (e.g., event 200) locally (e.g., using hardware/systems 208) and may save 108 the recording (e.g., recording 202) of the event (e.g., event 200) on the cloud-based storage platform (e.g., cloud-based storage platform 210).

Additionally/alternatively and when saving 106 a recording (e.g., recording 202) of the event (e.g., event 200) on an accessible storage platform (e.g., accessible storage platform 204), content acquisition process 10 may automatically save 110 the recording (e.g., recording 202) of the event (e.g., event 200) on a local storage device (e.g., local storage device 212); and automatically upload 112 the recording (e.g., recording 202) of the event (e.g., event 200) from the local storage device (e.g., local storage device 212) to the cloud-based storage platform (e.g., cloud-based storage platform 210). Accordingly and is such a configuration, content acquisition process 10 may capture information relating to the event (e.g., event 200) locally (e.g., using hardware/systems 208) and generate the recording (e.g., recording 202) of the event (e.g., event 200) locally and automatically save 110 the same on local storage device 212. Content acquisition process 10 may then automatically upload 112 the recording (e.g., recording 202) of the event (e.g., event 200) from the local storage device (e.g., local storage device 212) to the cloud-based storage platform (e.g., cloud-based storage platform 210).

The recording (e.g., recording 202) of the event (e.g., event 200) may include one or more of: an audio component; a video component; a graphical component; and a text component. As this event is a personal training session hosted by Jillian Michaels, the resulting recording (e.g., recording 202) may include:
a video component that provides shows a motion-based component of the personal training session (e.g., event 200);
an audio component that provides an audio-based component of the personal training session (e.g., event 200);
a graphical component that provides graphical-based information (e.g., animation overlays) during the personal training session (e.g., event 200); and
a text component that provides text-based information (e.g., name overlays) during the personal training session (e.g., event 200).

In addition to saving 106 a recording (e.g., recording 202) of the event (e.g., event 200) on an accessible storage platform (accessible storage platform 204), content acquisition process 10 may stream 114 the event (e.g., event 200) for synchronous viewing/participation by one or more remote attendees (e.g., remote attendees 214). As the event (e.g., event 200) is a personal training event being held at a local gym in Los Angeles, Calif. that is being headlined by Jillian Michaels, it is foreseeable that this event (e.g., event 200) may be highly attended by both local attendees (e.g., at gym 206) as well as remote attendees (e.g., remote attendees 214).

Content acquisition process 10 may process 116 the recording (e.g., recording 202) of the event (e.g., event 200). For example and when processing 116 the recording (e.g., recording 202) of the event (e.g., event 200), content acquisition process 10 may:
compress 118 the recording (e.g., recording 202) of the event (e.g., event 200) to e.g., reduce the size of recording 202 and reduce network/computational loading;
encrypt 120 the recording (e.g., recording 202) of the event (e.g., event 200) to e.g., secure recording 202 so that recording 202 may only be viewed by authorized user;
encode 122 the recording (e.g., recording 202) of the event (e.g., event 200) to e.g., enable easier/more efficient transfer of the recording (e.g., recording 202);
edit 124 the recording (e.g., recording 202) of the event (e.g., event 200) to e.g., remove dead air, eliminate noise, filter distortion, insert animation overlays, and insert name overlays; and
brand 126 the recording (e.g., recording 202) of the event (e.g., event 200) to e.g., insert branding information concerning the producer/distributor of the recording (e.g., recording 202).

Content acquisition process 10 may enable 128 the asynchronous review of the recording (e.g., recording 202) of the event (e.g., event 200) by one or more asynchronous attendees (e.g., asynchronous attendees 216). For example and once the recording (e.g., recording 202) of the event (e.g., event 200) is available via the cloud-based storage platform (e.g., cloud-based storage platform 210), the one or more asynchronous attendees (e.g., asynchronous attendees 216) may access the appropriate portion of cloud-based storage platform 210 so that the recording (e.g., recording 202) of the event (e.g., event 200) is accessible by the one or more asynchronous attendees (e.g., asynchronous attendees 216). Access to the recording (e.g., recording 202) of the event (e.g., event 200) may be controlled. For example, the recording (e.g., recording 202) of the event (e.g., event 200) may be configured to be available to any and all asynchronous attendees (e.g., asynchronous attendees 216) without e.g., requiring any special privileges or the payment of a fee.

Alternatively, the recording (e.g., recording 202) of the event (e.g., event 200) may be positioned behind a paywall and may be only available to those asynchronous attendees (e.g., asynchronous attendees 216) that e.g., have the appropriate privileges and/or have paid an access fee. For example, all members of the facility (e.g., gym 206) hosting the event (e.g., event 200) may have access to the recording (e.g., recording 202) of the event (e.g., event 200). Alternatively, only members of the facility (e.g., gym 206) hosting the event (e.g., event 200) that have a particular higher-end membership may have access to the recording (e.g., recording 202) of the event (e.g., event 200), Further, only members of the facility (e.g., gym 206) hosting the event (e.g., event 200) may have access to the recording (e.g., recording 202) of the event (e.g., event 200) but such access will require the payment of an additional fee. Additionally, if the facility (e.g., gym 206) hosting the event (e.g., event 200) is a specific location of a larger corporate organization that has facilities (e.g., gyms) across the country, members of any of those facilities (e.g., gyms) across the country may have access to the recording (e.g., recording 202) of the event (e.g., event 200), be it for free, or requiring the payment of an additional fee, or requiring a certain membership level.

When enabling 128 the asynchronous review of the recording (e.g., recording 202) of the event (e.g., event 200) by one or more asynchronous attendees (e.g., asynchronous attendees 216), content acquisition process 10 may enable 130 the one or more asynchronous attendees (e.g., asynchronous attendees 216) to stream the recording (e.g., recording 202) of the event (e.g., event 200). For example, the recording (e.g., recording 202) of the event (e.g., event 200) may be made available to the asynchronous attendees (e.g., asynchronous attendees 216) in a streaming fashion so that the recording (e.g., recording 202) of the event (e.g., event 200) is viewable by the asynchronous attendees (e.g., asynchronous attendees 216) but not locally storable by the asynchronous attendees (e.g., asynchronous attendees 216).

Additionally/alternatively and when enabling 128 the asynchronous review of the recording (e.g., recording 202) of the event (e.g., event 200) by one or more asynchronous attendees (e.g., asynchronous attendees 216), content acquisition process 10 may enable 132 the one or more asynchronous attendees (e.g., asynchronous attendees 216) to download the recording (e.g., recording 202) of the event (e.g., event 200). For example, the recording (e.g., recording 202) of the event (e.g., event 200) may be made available to the asynchronous attendees (e.g., asynchronous attendees 216) in a downloadable fashion so that the recording (e.g., recording 202) of the event (e.g., event 200) is downloadable and locally storable by the asynchronous attendees (e.g., asynchronous attendees 216).

Certification (Overview)

While the event (e.g., event 200) described above is a personal training event being held at a local gym in Los Angeles, Calif. that is being headlined by Jillian Michaels (i.e., an American personal trainer, businesswoman, author and television personality), this is for illustrative purposes only. Accordingly, the event (e.g., event 200) may be more professional in nature. For example, assume that event 200 is a CLE (e.g., Continuing Legal Education) event whose attendance is required for a lawyer to maintain their license to practice law within a particular jurisdiction. Accordingly and in this example, the asynchronous attendees (e.g., asynchronous attendees 216) may be lawyers that are required to review the recording (e.g., recording 202) of the event (e.g., event 200) to maintain their law license. Accordingly, content acquisition process 10 may memorialize 134 the asynchronous review of the recording (e.g., recording 202) of the event (e.g., event 200) by the one or more asynchronous attendees (e.g., asynchronous attendees 216).

When memorializing 134 the asynchronous review of the recording (e.g., recording 202) of the event (e.g., event 200) by the one or more asynchronous attendees (e.g., asynchronous attendees 216), content acquisition process 10 may certify 136 the asynchronous review of the recording (e.g., recording 202) of the event (e.g., event 200) by the one or more asynchronous attendees (e.g., asynchronous attendees 216), thus generating one or more certifications (e.g., certifications 218). For example and in order to enable certification 136, content acquisition process 10 may monitor the actions of the one or more asynchronous attendees (e.g., asynchronous attendees 216) to ensure that e.g., the asynchronous attendees 216 reviewed the recording (e.g., recording 202) of the event (e.g., event 200) in its entirety, which may be done by requiring the asynchronous attendees 216 to periodically interact with content acquisition process 10 by e.g., clicking their mouse or tapping their screen.

Additionally and when memorializing 134 the asynchronous review of the recording (e.g., recording 202) of the event (e.g., event 200) by the one or more asynchronous attendees (e.g., asynchronous attendees 216), content acquisition process 10 may provide 138 the one or more certifications (e.g., certifications 218) to a third-party certification entity (e.g., certification authority 220). For example, content acquisition process 10 may provide 138 certifications 218 to certification authority 220 (e.g., a state bar association) confirming that the one or more asynchronous attendees (e.g., asynchronous attendees 216) reviewed the recording (e.g., recording 202) of the event (e.g., event 200) in its entirety.

General

As will be appreciated by one skilled in the art, the present disclosure may be embodied as a method, a system, or a computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. The computer-usable or computer-readable medium may also be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present disclosure may be written in an object oriented programming language such as Java, Smalltalk, C++ or the like. However, the computer program code for carrying out operations of the present disclosure may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network/a wide area network/the Internet (e.g., network 14).

The present disclosure is described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer/special purpose computer/other programmable data processing apparatus, such that the instructions, which execute via the processor of the computer or other programmable data processing apparatus, create means for implementing the functions/acts specified in the flowchart and/or block diagram block or blocks.

These computer program instructions may also be stored in a computer-readable memory that may direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowcharts and block diagrams in the figures may illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

A number of implementations have been described. Having thus described the disclosure of the present application in detail and by reference to embodiments thereof, it will be apparent that modifications and variations are possible without departing from the scope of the disclosure defined in the appended claims.

What is claimed is:

1. A computer-implemented method executed on a computing device comprising:
saving a recording of an event on an accessible storage platform;
enabling the asynchronous review of the recording of the event by one or more asynchronous attendees; and
memorializing the asynchronous review of the recording of the event by the one or more asynchronous attendees.

2. The computer-implemented method of claim 1 further comprising:
defining the event;

3. The computer-implemented method of claim 2 wherein defining an event includes one or more of:
scheduling an event using an event platform; and
scheduling a time, a date and a periodicity for the event.

4. The computer-implemented method of claim 1 wherein saving a recording of the event on an accessible storage platform includes:
automatically saving a recording of the event on a cloud-based storage platform

5. The computer-implemented method of claim 1 wherein saving a recording of the event on an accessible storage platform includes:
automatically saving the recording of the event on a local storage device; and
automatically uploading the recording of the event from the local storage device to a cloud-based storage platform.

6. The computer-implemented method of claim 1 wherein enabling the asynchronous review of the recording of the event by one or more asynchronous attendees includes one or more of:
enabling the one or more asynchronous attendees to stream the recording of the event; and
enabling the one or more asynchronous attendees to download the recording of the event.

7. The computer-implemented method of claim 1 wherein memorializing the asynchronous review of the recording of the event by the one or more asynchronous attendees includes:
certifying the asynchronous review of the recording of the event by the one or more asynchronous attendees, thus generating one or more certifications.

8. The computer-implemented method of claim 7 wherein memorializing the asynchronous review of the recording of the event by the one or more asynchronous attendees includes:
providing the one or more certifications to a third-party certification entity.

9. The computer-implemented method of claim 1 further comprising:
streaming the event for synchronous viewing/participation by one or more remote attendees.

10. The computer-implemented method of claim 1 wherein the recording of the event includes one or more of:
an audio component;
a video component;
a graphical component; and
a text component.

11. A computer program product residing on a computer readable medium having a plurality of instructions stored thereon which, when executed by a processor, cause the processor to perform operations comprising:
saving a recording of an event on an accessible storage platform;
enabling the asynchronous review of the recording of the event by one or more asynchronous attendees; and
memorializing the asynchronous review of the recording of the event by the one or more asynchronous attendees.

12. The computer program product of claim 11 further comprising:
defining the event.

13. The computer program product of claim 12 wherein defining an event includes one or more of:
scheduling an event using an event platform; and
scheduling a time, a date and a periodicity for the event.

14. The computer program product of claim 11 wherein saving a recording of the event on an accessible storage platform includes:
automatically saving a recording of the event on a cloud-based storage platform.

15. The computer program product of claim 11 wherein saving a recording of the event on an accessible storage platform includes:
automatically saving the recording of the event on a local storage device; and
automatically uploading the recording of the event from the local storage device to a cloud-based storage platform.

16. The computer program product of claim 11 wherein enabling the asynchronous review of the recording of the event by one or more asynchronous attendees includes one or more of:
enabling the one or more asynchronous attendees to stream the recording of the event; and
enabling the one or more asynchronous attendees to download the recording of the event.

17. The computer program product of claim 11 wherein memorializing the asynchronous review of the recording of the event by the one or more asynchronous attendees includes:
certifying the asynchronous review of the recording of the event by the one or more asynchronous attendees, thus generating one or more certifications.

18. The computer program product of claim 17 wherein memorializing the asynchronous review of the recording of the event by the one or more asynchronous attendees includes:
providing the one or more certifications to a third-party certification entity.

19. The computer program product of claim 11 further comprising:
streaming the event for synchronous viewing/participation by one or more remote attendees.

20. The computer program product of claim 11 wherein the recording of the event includes one or more of:
an audio component;
a video component;
a graphical component; and
a text component.

21. A computing system including a processor and memory configured to perform operations comprising:
saving a recording of an event on an accessible storage platform;
enabling the asynchronous review of the recording of the event by one or more asynchronous attendees; and
memorializing the asynchronous review of the recording of the event by the one or more asynchronous attendees.

22. The computing system of claim 21 further comprising:
defining the event.

23. The computing system of claim 22 wherein defining an event includes one or more of:
scheduling an event using an event platform; and
scheduling a time, a date and a periodicity for the event.

24. The computing system of claim 21 wherein saving a recording of the event on an accessible storage platform includes:
automatically saving a recording of the event on a cloud-based storage platform.

25. The computing system of claim 21 wherein saving a recording of the event on an accessible storage platform includes:
automatically saving the recording of the event on a local storage device; and
automatically uploading the recording of the event from the local storage device to a cloud-based storage platform.

26. The computing system of claim 21 wherein enabling the asynchronous review of the recording of the event by one or more asynchronous attendees includes one or more of:
enabling the one or more asynchronous attendees to stream the recording of the event; and
enabling the one or more asynchronous attendees to download the recording of the event.

27. The computing system of claim 21 wherein memorializing the asynchronous review of the recording of the event by the one or more asynchronous attendees includes:
certifying the asynchronous review of the recording of the event by the one or more asynchronous attendees, thus generating one or more certifications.

28. The computing system of claim 27 wherein memorializing the asynchronous review of the recording of the event by the one or more asynchronous attendees includes:
providing the one or more certifications to a third-party certification entity.

29. The computing system of claim 21 further comprising:
streaming the event for synchronous viewing/participation by one or more remote attendees.

30. The computing system of claim 21 wherein the recording of the event includes one or more of:
an audio component;
a video component;
a graphical component; and
a text component.
